(19) United States
(12) Patent Application Publication
(10) Pub. No.: US 2005/0218153 A1
(43) Pub. Date: Oct. 6, 2005

(54) Space saver

(76) Inventor: David John Dejeu, Parkland, WA (US)

Correspondence Address: DAVID JOHN DEJEU, 145 138TH ST E., PARKLAND, WA, 98445, US

(21) Appl. No.: 11/029,058

(22) Filed: Jan. 3, 2005

Related U.S. Application Data
(60) Provisional application No. 60/534,271, filed on Jan. 5, 2004.

(51) Int. Cl. B65G 59/00

(52) U.S. Cl. 221/251

(57) ABSTRACT

A canned food dispenser comprising: a) an opening at the top through which said canned food is to be placed through and a bottom front opening through which said canned food is to be retrieved from; b) a platform at the bottom front of said dispenser that extends horizontally outward approxamatly three inches with a stopper at the end that extends upward vertically which is used to bring said canned food to a stop until it is retrieved by said person; c) a slot on back of said canned food dispeser through which a custom made hook can be placed and said canned food dispenser can then be hung on a door; d) Said canned food dispenser is designed to hold multiple various sized canned foods and are available in a wide version for the more common sized said canned foods and a skinnier version for the flat said canned foods.

### CROSS-REFERENCE TO RELATED APPLICATIONS

Provisional Patent Application Ser. No. 60/534,271 filed 2004 Jan. 5.

### DESCRIPTION

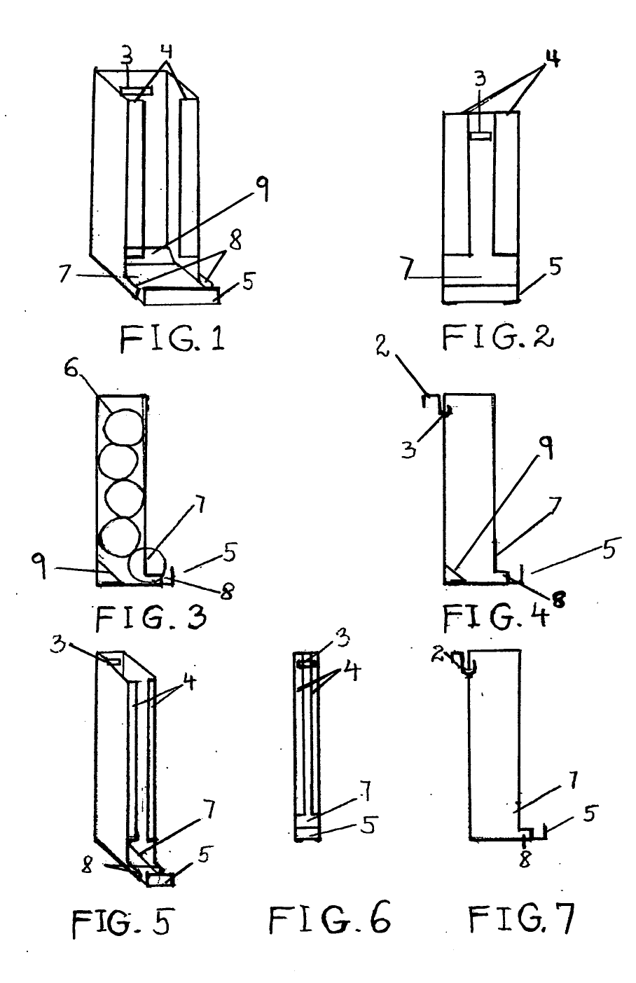

FIG. 1 is a perspective view of The Space Saver from the front and slightly right angle in order to show The Space Saver three dimensionally. The outside walls serve as the frame of The Space Saver including walls 4, which are located at the front of The Space Saver. Walls 4 only extend partially inward to allow for a said persons fingers to grip the said canned-food, in-order to guide it vertically downward from the top to the bottom of The Space Saver, or until the said canned-food makes contact with another canned-food(s) already in the compartment. Walls 4 also serve the purpose of keeping said canned-foods in The Space Saver's compartment. Slot 3 serves as an opening where an optional hook can be attached as to allow for mounting of The Space Saver onto a door. The opening 7 serves as the bottom oppening; this is where the said canned-food is to be retrieved from. Bottom walls 5 and 8 serve to keep said canned-food in place, and to prevent it from falling out. Bottom walls 8 also gives added strength to the structure of The Space Saver. Ramp 9 serves as a ramp that is designed to keep the said bottom canned food slightly more forward than the said canned foods that are to be placed on top of it.

FIG. 2 is a front perspective view of The Space Saver, which lists all of the same functions of FIG. 1; the slot 3, the walls 4, the opening 7, and the bottom wall 5.

FIG. 3 is a side perspective view of The Space Saver, which demonstrates approximately how the canned-foods 6 would look from a side view placed inside The Space Saver. Canned-foods 6 are to be placed into The Space Saver from the top, lowered to the bottom thru opening 7, and left to rest against bottom walls 5 and 8, from where the said canned-food can be retrieved. Ramp 9 demonstrates how the bottom said canned food is left with no other option but to be forced forward by the weight of the said canned food(s) that are to be placed on top of it.

FIG. 4 is a side perspective view of The Space Saver while it is empty, which shows how the optional hook 2 can be placed Into the slot 3 for mounting onto a door. Again showing the opening 7, the bottom walls 5 and 8, and the ramp 9.

FIG. 5 is a perspective view of the thinner version of The Space Saver from the front and slightly right angle in order to show The Space Saver three dimensionally. All of the parts serve the same purpose (the walls 4, the slot 3, the opening 7, and the bottom walls 5 and 8), and have the same funtions as in FIG. 1.

FIG. 6 is a front perspective view of the thinner version of The Space Saver. All of the parts serve the same purpose (the walls 4, the slot 3, the opening 7, and the bottom wall 5), and have the same funtions as in FIG. 5.

FIG. 7 is a side perspective view of the thinner version of The Space Saver. All of the parts serve the same purpose (the hook 2, the slot 3, the opening 7, and the bottom walls 5 and 8), and have the same functions as in FIG. 4.

### OPERATION

In operation one places canned-foods 6 sideways and one at a time into The Space Saver, from the top into the compartment. The canned-foods 6 are then retrieved from bottom opening 7 of the compartment. Hook 2 is optional and is only needed if The Space Saver will be hooked to a door, along with additional screws that are to be drivin through The Space Saver Itself, into the door that The Space Saver will be mounted to, for added safety and support. The Space Saver may also be mounted to a wall by simply removing the hook 2 and then placing The Space Saver onto the wall. The next step is to fasten The Space Saver into place with screws, through the back of The Space Saver and into the stud of the wall. After The Space Saver is mounted and screwed into the desired location one can start to free-up a lot of cupboard or pantry space, by transfering canned foods from the cupboard or pantry into The Space Saver. With The Space Saver one can keep their kitchen or pantry more organized by knowing what type of canned food is in each Space Saver. Multiple Space Savers may be used. The Space Saver may also be used by simply being placed on top of a flat surface such as a counter top.

1. A canned food dispenser and organizer comprising:
a rectangular compartment with openings at the top and bottom, which stores said canned foods, which can be placed in the said compartments from the top and then be retrieved from the bottom of the said compartment.
a bottom wall or stopper which extends upwardly approximately two inches at the bottom front of The Space Saver which serves its purpose by stopping the said canned-food until it is physically removed by a said individual.
a bottom wall on both sides of The Space Saver which gives The Space Savers structure extra support, and on the thinner version of The Space Saver assures that said canned-food does not fall out thru the sides.
a partial wall which extends inwardly and comes down vertically from both sides of the front of The Space Saver and leaving a bottom opening big enough for various sized canned-foods to fit through.
a rectangular slot on the back of The Space Saver with a S shaped optional hook that can be placed thru the slot for mounting onto a door.
an angled ramp which is designed to push the said canned food that is placed on the bottom to be pushed slightly more forward than the said canned food(s) that are placed on top of it; which makes the said canned food role forward due to the weight that is placed on top of it.
